(19) United States
(12) Patent Application Publication
(10) Pub. No.: US 2014/0029658 A1
(43) Pub. Date: Jan. 30, 2014

(54) Analog/Digital Co-Design Methodology to Achieve High Linearity and Low Power Dissipation in a Radio Frequency (RF) Receiver

(71) Applicants: Helen Kim, Sudbury, MA (US); Merlin Green, Salem, MA (US); Andrew Bolstad, Arlington, MA (US); Daniel D. Santiago, Waltham, MA (US); Michael N. Ericson, Waltham, MA (US); Karen Gettings, Carlisle, MA (US); Benjamin A. Miller, Cambridge, MA (US)

(72) Inventors: Helen Kim, Sudbury, MA (US); Merlin Green, Salem, MA (US); Andrew Bolstad, Arlington, MA (US); Daniel D. Santiago, Waltham, MA (US); Michael N. Ericson, Waltham, MA (US); Karen Gettings, Carlisle, MA (US); Benjamin A. Miller, Cambridge, MA (US)

(73) Assignee: Massachusetts Institute of Technology, Cambridge, MA (US)

(21) Appl. No.: 13/558,651

(22) Filed: Jul. 26, 2012

(51) Int. Cl. H04B 1/16; H04L 27/01; H04B 17/00

(52) U.S. Cl. 375/229; 455/334; 455/226.1

(57) ABSTRACT

Receiver design techniques are provided that are capable of producing relatively efficient, linear radio frequency (RF) receivers. During a design process, components of an analog receiver chain and digital nonlinearity compensation techniques are considered together to achieve reduced power consumption in the receiver.

### GOVERNMENT RIGHTS

This invention was made with government support under Contract No. FA8721-05-C-0002 awarded by the US Air Force. The government has certain rights in this invention.

### CROSS REFERENCE TO RELATED APPLICATIONS

Not applicable.

### FIELD

Subject matter disclosed herein relates generally to radio frequency (RF) systems and, more particularly, to techniques for designing RF receivers.

### BACKGROUND

Radio frequency (RF) receivers are complex electronic systems that are typically required to meet strict performance specifications. One performance parameter that is sometimes difficult to achieve in an RF receiver is linearity. To achieve a specified linearity requirement, digital compensation circuitry may sometimes be added to an analog receiver design to suppress non-linear distortion components in an output signal of the analog receiver. Techniques are needed for designing RF receiver systems that use digital nonlinearity compensation.

### SUMMARY

In accordance with the concepts, systems, circuits, and techniques described herein, a method to design a receiver system comprises: generating an initial analog receiver design; characterizing nonlinearities in the initial analog receiver design; designing digital nonlinearity compensation circuitry for the initial analog receiver design based on the nonlinearities and applying the digital nonlinearity compensation circuitry to the initial analog receiver design; and modifying the analog receiver design and the digital nonlinearity compensation circuitry to identify a combination of the two that achieves a receiver linearity requirement with relatively low power consumption.

In accordance with a further aspect of the concepts, systems, circuits and techniques described herein, a method for designing a receiver comprising an analog receiver chain followed by a digital equalization circuit comprises: selecting components for the analog receiver chain that allow the analog receiver chain to achieve receiver design requirements other than a receiver linearity requirement; and designing the digital equalization circuit to reduce non-linear distortion components in an output signal of the analog receiver chain in a manner that achieves the receiver linearity requirement; wherein selecting components for the analog receiver chain includes selecting components having nonlinear characteristics that require a relatively small number of computations within the digital equalization circuit to achieve the receiver linearity requirement.

In accordance with a still further aspect of the concepts, systems, circuits, and techniques described herein, a method for designing a receiver comprising an analog receiver chain followed by a digital compensation circuit comprises: identifying multiple candidate analog receiver chain designs that are capable of achieving receiver design requirements other than a receiver linearity requirement; designing digital compensation circuits for each of the candidate analog receiver chain designs to achieve the receiver linearity requirement; and selecting an analog receiver chain/digital compensation circuit combination having a lowest power consumption.

In accordance with another aspect of the concepts, systems, circuits, and techniques described herein, a method for designing a receiver system comprises: generating an analog receiver design based on specified system requirements; defining operational constraints for components of the analog receiver design to limit nonlinearity in the analog receiver design while achieving component performance requirements; characterizing non-linearities in the analog receiver design operating under the operational constraints; and designing supplemental digital compensation circuitry for the analog receiver design operating under the operational constraints to reduce non-linear distortion components in an output signal thereof; wherein generating an analog receiver design includes selecting components for the analog receiver design that are known to require a low level of supplemental digital compensation to achieve a receiver linearity requirement.

In accordance with yet another aspect of the concepts, systems, circuits, and techniques described herein, a method for designing a receiver system comprises: designing an analog receiver circuit based, at least in part, on specified receiver requirements; selecting circuit parameters for the analog receiver circuit based, at least in part, on the specified receiver requirements; identifying nonlinear distortion components in an output signal of the analog receiver circuit and sources of the nonlinear distortion components within the analog receiver circuit; designing a digital compensation circuit for the analog receiver circuit to reduce nonlinear distortion components within the output signal of the analog receiver circuit and estimating power consumption of the digital compensation circuit; measuring linearity of the digitally compensated analog receiver circuit and, if a receiver linearity requirement has not been achieved, repeating identifying nonlinear distortion components, designing a digital compensation circuit, and measuring linearity until the receiver linearity requirement is achieved; and when the system linearity requirement has been achieved, determining whether a power condition has been satisfied and, if not, repeating designing an analog receiver circuit, selecting circuit parameters, identifying nonlinear distortion components, designing a digital compensation circuit, measuring linearity, and determining until the power condition has been satisfied.

In accordance with still another aspect of the concepts, systems, circuits, and techniques described herein, a receiver system comprises: an analog receiver chain having a plurality of analog circuit components, each of the analog circuit components having known nonlinear response characteristics; and a digital equalizer coupled to an output of the analog receiver chain, the digital equalizer to reduce one or more nonlinear distortion components in an output signal of the analog receiver chain to achieve a receiver linearity requirement, wherein the circuit components of the analog receiver chain are selected to achieve low power consumption in the digital equalizer.

### BRIEF DESCRIPTION OF THE DRAWINGS

FIGS. 1 and 2 are portions of a flowchart illustrating a method for use in designing a radio frequency (RF) receiver system in accordance with an embodiment;

FIG. 3 is a block diagram illustrating an example analog receiver architecture that may be considered during a receiver design process in accordance with an embodiment;

FIG. 4 is a block diagram illustrating an example analog receiver architecture with digital compensation circuitry that may be considered during a receiver design process in accordance with an embodiment;

FIG. 5 is a block diagram illustrating an example digital equalizer circuit that may be used to provide nonlinearity compensation for an analog receiver design in accordance with an embodiment;

FIG. 6 is a block diagram of an example processing element that may be used within the digital equalizer circuit of FIG. 5 in accordance with an embodiment;

FIGS. 7 and 8 are schematic diagrams of an amplifier circuit having feedback that may be considered for use as a buffer amplifier during a receiver design process in accordance with an embodiment;

FIGS. 9 and 10 are schematic diagrams of an amplifier circuit without feedback that may be considered for use as a buffer amplifier during a receiver design process in accordance with an embodiment;

FIG. 11 is a plot illustrating responses for a first receiver having a buffer that uses feedback and a second receiver having a buffer that does not use feedback;

FIG. 12 is a plot illustrating measured spurious free dynamic range (SFDR) for a receiver having a buffer that uses feedback, for various levels of digital compensation;

FIG. 13 is a plot illustrating measured SFDR for a receiver having a buffer that does not use feedback, for various levels of digital compensation; and

FIGS. 14 and 15 are portions of a flowchart illustrating a method for use in designing an RF receiver system in accordance with another embodiment.

### DETAILED DESCRIPTION

Subject matter described herein relates to techniques and concepts for designing radio frequency (RF) receiver systems. The receiver systems that are designed using these techniques may utilize both analog and digital compensation strategies to achieve a desired level of linearity performance. As will be described in greater detail, the design techniques consider analog and digital design together in a manner that can achieve linear receiver performance with relatively low power consumption.

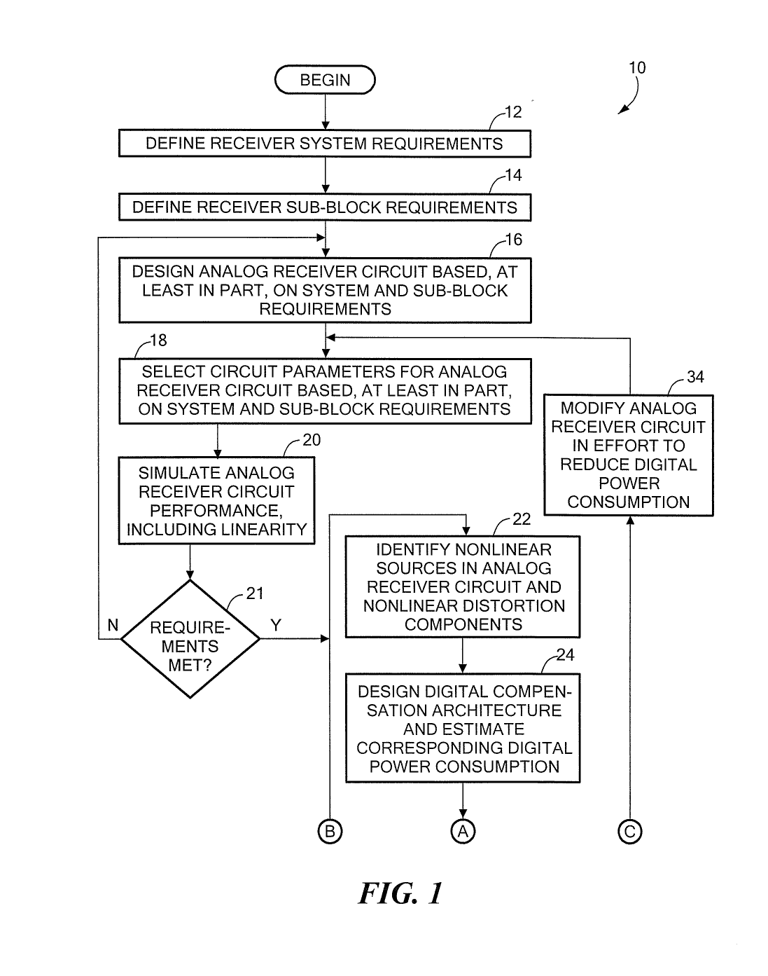

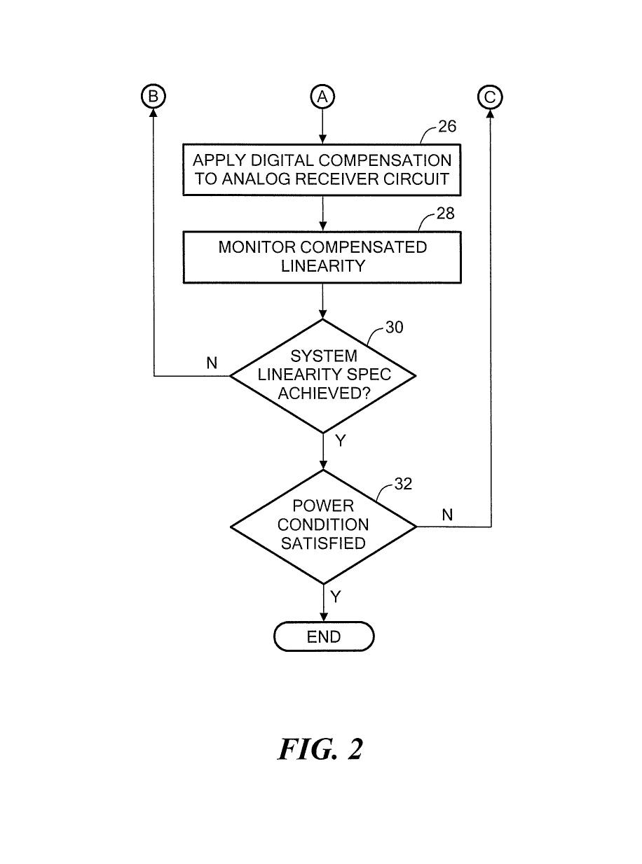

FIGS. 1 and 2 are portions of a flowchart illustrating a method 10 for use in designing a radio frequency (RF) receiver system in accordance with an embodiment. The method 10 is capable of generating receiver system designs that achieve a desired level of linearity, while consuming significantly less power than receivers designed using conventional design techniques. In general, low power RF receivers are highly desirable. Such receivers are particularly desirable for use in battery powered communication applications, where low power consumption leads to longer periods between battery recharge operations (e.g., cell phones, smart phones, walkie talkies, pagers, satellite communicators, etc.).

As shown in FIG. 1, the method 10 may begin with the definition of system requirements for the receiver system being designed (block 12). The system requirements may include a designation of performance parameters for the receiver system that may include, for example, selectivity, bandwidth, linearity, sensitivity, noise figure, dynamic range, signal-to-noise ratio (SNR), and/or other parameters. Requirements for individual sub-blocks of the receiver system (which may include individual components or groups of components of the analog receiver chain) may also be defined (block 14). For example, there may be individual linearity or bandwidth requirements for an amplifier, frequency converter, filter, VGA, and/or other elements or groups of elements within the receiver chain. In some implementations, some or all of the system and/or sub-block requirements may be specified by a customer, a standard, and/or government regulation.

An analog receiver system architecture may next be selected based, at least in part, on the system and/or sub-block requirements (block 16). The selection of an initial analog receiver architecture may include considerations such as, for example, whether a pre-selector should be used, how many frequency conversion stages should be used (e.g., direct conversion receiver, super-heterodyne receiver, etc.), how many filter stages should be used, how many amplification stages should be used, whether separate in-phase (I) and quadrature (Q) channels should be provided, whether a trans-impedance amplifier (TIA) should be used, whether analog circuit linearization techniques should be implemented for one or more components of the receiver chain and, if so, what types of analog linearization techniques to use, and/or other considerations.

Circuit parameters and operational conditions may also be selected for the analog receiver system based, at least in part, on the system and/or sub-block requirements (block 18). The circuit parameters may include parameters such as, for example, the transconductance (gₘ) of one or more transistor devices, the sizes of transistor devices (e.g., length, width, etc.), bias levels of active devices within the receiver chain (e.g., I_{bias}, etc.), power levels at various points within the receiver chain (e.g., at the output of an LNA, at the input or output of one or more VGAs, at the input or output of a buffer amplifier, etc.), and/or other parameters. The bias levels and power levels may be selected, for example, to keep one or more of the components within the analog circuitry within a desired region of operation. For example, in at least one example implementation, the bias levels and drive levels of all amplifiers within the analog receiver chain may be set so that they do not exceed the 1-dB gain compression point under any circumstances. By limiting operational parameters in this manner, digital nonlinearity compensation may be simplified while meeting high SFDR. In another example, the analog receiver chain can be designed beyond 1-dB gain compression point when SFDR is not as demanding.

After the initial analog architecture and analog circuit parameters have been selected, the performance of the analog receiver circuit may be simulated to determine whether selected system and/or sub-block requirements have been achieved (block 20). If the requirements have not been achieved, changes may be made to the architecture and/or circuit parameters until desired analog performance is achieved for those requirements (block 21). Because digital nonlinearity compensation is to be used, however, the system linearity requirement does not need to be satisfied at this point.

After an analog design is determined, digital design techniques for reducing the level of one or more nonlinear distortion components (e.g., inter-modulation (inter-mod) products, harmonics, etc.) in an output of the analog receiver circuit may be implemented. As a first step in the digital design process, nonlinear distortion components in the analog output signal, as well as the sources of these components, may be identified (block 22). In some implementations, a calibration procedure may be used to identify the nonlinear distortion components being generated in the receiver. The calibration procedure may involve, for example, applying a series of two-tone signals to an input of the analog receiver circuit and monitoring, recording, and analyzing resulting output signals.

Based on the identified nonlinear components and sources, a digital compensation architecture may be designed for reducing or eliminating the nonlinear distortion components in the output of the analog receiver circuit (block 24). In at least one embodiment, the digital compensation circuitry may include one or more analog to digital converters (ADCs) coupled to an output of the analog receiver chain(s) followed by digital processing circuitry (e.g., a digital equalizer, etc.) that is configured to digitally suppress one or more of the nonlinear distortion components within the output signal of the analog receiver chain. The power consumption of the resulting digital compensation circuitry may be estimated at this point.

Referring now to FIG. 2, the digital compensation architecture may next be applied to the analog receiver system (block 26). The linearity performance of the modified system may then be simulated (block 28). If the modified system does not achieve the specified system linearity requirement (block 30-N), then the method 10 may repeat the digital design process to make modifications to the digital compensation architecture. That is, nonlinear distortion components may again be identified (block 22) and adjustments may be made to the digital compensation architecture based thereon (block 26). This process may be repeated until the system linearity requirement has been achieved or some other condition has been met (e.g., a maximum number of design iterations has occurred, etc.). Each time the digital compensation architecture is modified, the power consumption of the modified architecture may again be estimated.

When the digitally modified system achieves the specified system linearity requirement (block 30-Y), then it may next be determined whether a particular power condition of the receiver system has been satisfied (block 32). As will be described in greater detail, the power condition may include any condition that is selected to achieve reduced power consumption in the digital compensation circuitry itself or the RF receiver design as a whole. If the power condition is not satisfied (block 32-N), then modifications may be made to the analog circuitry in an effort to achieve further reduction in power consumption in the receiver (block 34). In some implementations, the modifications to the analog circuitry may include modifications to only a single component of the analog receiver chain. For example, a type of analog linearity compensation being used in a particular component (e.g., an amplifier, etc.) may be changed. In other implementations, changes in more than one component may be made.

After the modifications have been made to the analog circuitry, the performance of the modified analog circuitry may then be simulated (block 20) and possibly further refined (block 21). As before, digital compensation may then be designed and applied for the modified analog circuitry until the system linearity requirement is again achieved (block 30-Y). The power condition may then be re-checked (block 32). This process may then be repeated until a digitally compensated receiver design is achieved that meets the linearity requirement while satisfying the power condition.

As described above, the power condition is a condition that is selected to achieve an overall receiver design that meets all of the design requirements, while consuming a reduced amount of power. In some implementations, reducing power consumption in the digital compensation circuitry may be a primary concern. However, in other embodiments, the power consumption of the entire receiver may be considered (i.e., both analog and digital portions). Thus, in some implementations, a design that uses slightly more digital power and a lot less analog power may be preferred over a design that reduces digital power substantially but consumes more power overall. In one approach, the power condition may be to achieve a minimum amount of power consumption in the digital compensation circuitry (or the receiver as a whole). However, it may be difficult or impossible to determine whether a “minimum” power consumption has been achieved in a particular instance. Therefore, other types of power conditions may alternatively be specified. In one implementation, for example, the power condition may involve performing a predetermined number of design iterations that each changes the analog and digital circuit designs. After the predetermined number of iterations have been performed, the receiver design that achieved the lowest digital power consumption (or overall power consumption) may be selected. In another possible approach, a desired level of power consumption may first be selected and then analog/digital design iterations may be performed until this level of power consumption is achieved. This approach can be modified to include a maximum number of design iterations in case the desired level of power consumption cannot be achieved (or is too difficult to achieve). As will be appreciated, any number of alternative power conditions can be used in other implementations.

FIG. 3 is a block diagram illustrating an example analog receiver architecture 50 that may be considered during a design process in accordance with an implementation. The analog receiver architecture 50 is an example of a direct conversion receiver that includes a single frequency conversion stage that down-converts a received signal directly to base band. As shown, the analog receiver architecture 50 may include, for example, a low noise amplifier (LNA) 52, a mixer 54, a variable gain amplifier (VGA) 56, an active filter 58, a buffer amplifier 60, and a frequency synthesizer 62. The LNA 52 is a high gain amplifier having a low noise figure that is operative for amplifying a signal received from a wireless channel by an antenna (not shown). Mixer 54 is operative for down converting the output signal of LNA 52 to baseband. Frequency synthesizer 62 generates a local oscillator (LO) signal for mixer 54 to support the down-conversion. VGA 56 amplifies the baseband signal output by mixer 54 by a controllable gain amount. Active filter 58 may include, for example, a low pass filter for filtering the amplified baseband signal before it reaches buffer amplifier 60. Buffer amplifier 60 then provides a final analog amplification stage for the analog architecture 50.

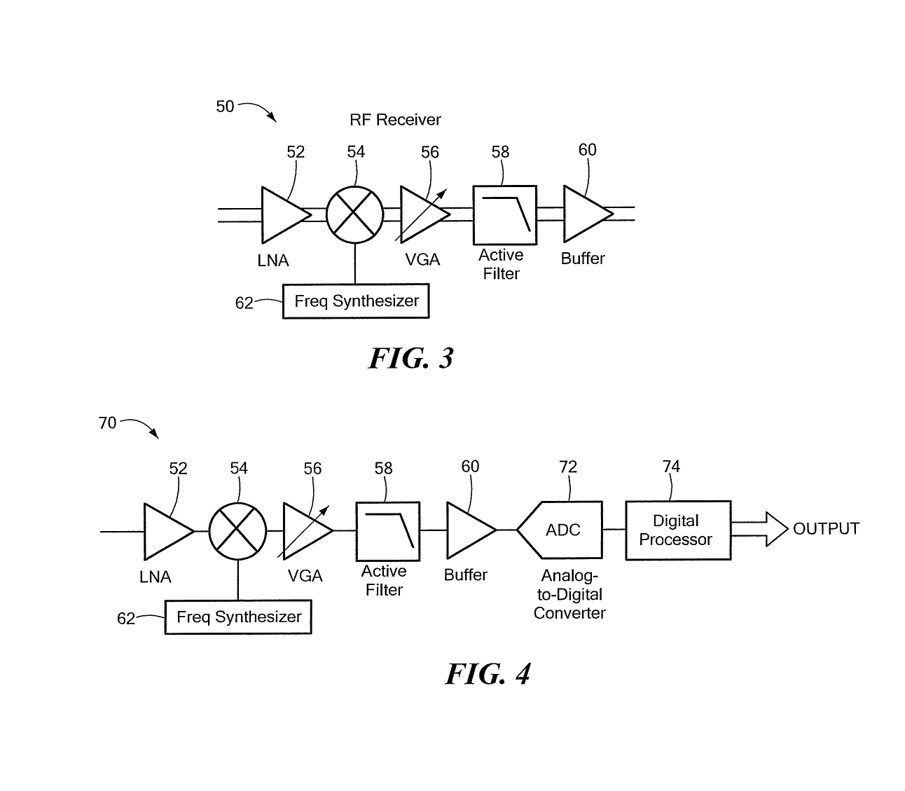

FIG. 4 is a block diagram illustrating an analog receiver architecture 70 having digital compensation circuitry. As shown, the receiver architecture 70 includes the analog receiver architecture 50 of FIG. 3 with an ADC 72 and a digital processor 74 added to an output thereof. ADC 72 is operative for digitizing the output signal of buffer amplifier 60 to support digital processing in digital processor 74. Digital processor 74 includes digital suppression circuitry (e.g., a digital equalizer, etc.) that is capable of suppressing one or more of the nonlinear distortion components within the output signal of the analog receive chain. In general, for a given analog receiver design, the complexity of digital processor 74 (e.g., the number of filter taps used, etc.) will typically dictate the amount of suppression achieved in the nonlinear signal components of the output signal. The amount of power consumed by processor 74 will typically increase with increased complexity. In addition, as will be described in greater detail, it has been discovered that the digital complexity required in digital processor 74 to achieve a desired linearity performance for a receiver system (e.g., receiver system 70) may not necessarily depend upon the linearity performance of the analog receiver chain being used. That is, in many cases, analog receiver designs having better linearity performance may require more complex digital compensation circuitry than other analog receiver designs having poorer linearity performance. The receiver design methods described herein (e.g., method 10 of FIGS. 1 and 2, etc.) are capable of finding a combination of analog and digital circuitry that achieves a desired linearity performance overall, while consuming a reduced, or in some cases minimal, amount of power.

It should be appreciated that analog receiver architecture 50 of FIG. 3 represents one possible analog receiver architecture that may be considered for use during a design process in accordance with an embodiment. Many alternative architectures, including much more complex receiver architectures, may be selected in other implementations. As described above, the particular architecture that is selected will depend, at least in part, on the particular system and/or sub-block requirements of the system.

In some implementations, a digital equalizer may be used as part of the digital compensation architecture to reduce nonlinear distortion components in the output signal of the analog receiver chain. In RF systems having memory effects (e.g., RF receivers, etc.), a general nonlinear finite impulse response (FIR) model that may be used to model nonlinear operation is the Volterra series, which may be expressed as:

$${y}_{NL} ( n ) = {\sum }_{p = 0}^{P} {\sum }_{{m}_{l} = 0}^{M} … {\sum }_{{m}_{p} = 0}^{M} {h}_{p} ( {m}_{1} , … , {m}_{p} ) {\prod }_{l = 1}^{p} x ( n - {m}_{l} ) .$$

where P is the polynomial order, M is the memory depth, hₚ are the Volterra coefficients, x is the input, and y_{NL} is the output. This model generalizes the linear FIR filter to polynomial combinations of the input. While this representation captures general nonlinear behavior, its complexity is combinatorial in memory depth (M). To enable use within real-time systems, some simplification of this model may be needed. In one possible simplification approach, a full coefficient space of the model may be divided into subspaces, and only a few of the subspaces may be selected for use in the equalizer. In addition, to achieve power savings, an equalizer may be designed that operates over only a portion of the coefficient space of the Volterra kernel, rather than the entire space.

When designing a digital compensation architecture, a digital equalizer circuit may be selected that uses coefficients of a generalized memory polynomial (GMP) architecture (such as the architecture described in “A Generalized Memory Polynomial Model for Digital Predistortion of RF Power Amplifiers,” by Morgan et al., IEEE Trans. Signal Process., Vol. 54, No. 10, 2006). In this model, the nonlinear output (neglecting the constant h₀ and linear h₁ terms) may be given by:

$$y ( n ) = {\sum }_{p = 2}^{P} {\sum }_{{m}_{1} = 0}^{{M}_{1}} {\sum }_{{m}_{2} = 0}^{{M}_{2}} {h}_{p} ( {m}_{1} , {m}_{2} ) x ( n - {m}_{1} ) {x}^{p - 1} ( n - {m}_{1} - {m}_{2} )$$

This model is restricted to the coefficients lying on a 2-dimensional plane within the larger coefficient space. The model limits flexibility in that coefficients may no longer be chosen from arbitrary portions of the space, but it provides a simple, power-efficient implementation. From the set of possible GMP coefficients, a small number of non-zero coefficients may be selected (e.g., up to five in one implementation) using a sparse signal estimation procedure. In one implementation, a procedure is used that is a modified version of the orthogonal matching pursuit (OMP) algorithm described in “Signal Recovery From Random Measurements via Orthogonal Matching Pursuit,” by Tropp et. al, IEEE Trans. Inform. Theory, Vol. 53, No. 12, pp. 4655-4666, December 2007. It has been empirically observed that allowing the procedure to choose individual coefficients permits a greater initial dynamic range improvement to be achieved with few coefficients in a manner that is sufficient to compensate for nonlinearity in many analog receiver designs.

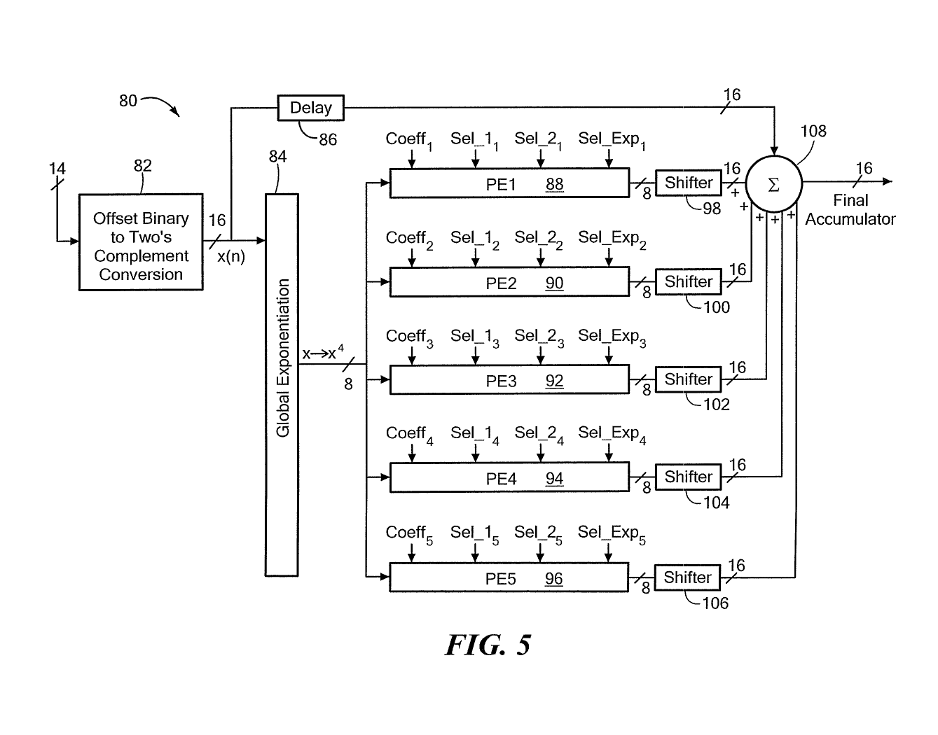

FIG. 5 is a block diagram illustrating a digital equalizer circuit 80 that may be used to provide nonlinearity compensation for an analog receiver design (or other circuit designs) in accordance with an embodiment. Digital equalizer circuit 80 may be used within, for example, digital processor 74 of FIG. 4 or in other systems. In some embodiments, digital equalizer circuit 80 may be configured to select and use a small number of non-zero GMP coefficients using a sparse signal estimation procedure, as described above. As illustrated, digital equalizer circuit 80 comprises: a two's complement converter 82; a global exponentiation unit 84; a delay unit 86; a plurality of processing elements (PEs) 88, 90, 92, 94, 96; a plurality of digital shifters 98, 100, 102, 104, 106 corresponding to the plurality of processor elements; and an output accumulator 108. As described previously, a signal output by an analog receiver chain may first be converted to a digital format within an analog to digital converter (ADC) before being input into digital equalizer circuit 80. Two's complement converter 82 is operative for converting the input data to a two's complement format, if needed. The output of two's complement converter 82 will be denoted as x(n) herein and, in at least one embodiment, is a 16-bit signal.

Global exponentiation unit 84 is operative for raising signal x(n) to powers ranging from 2 to 4 to provide polynomial combinations of the signal for processing (e.g., x(n) to x⁴(n)). To save power in digital equalizer circuit 80, signal x(n) may be truncated to a particular number of most significant bits (MSBs) (e.g., 8 bits, etc.) before being applied to global exponentiation unit 84, in some embodiments. As will be described in greater detail, PEs 88, 90, 92, 94, 96 process the polynomial combinations output by global exponentiation unit 84 in a predetermined manner to each generate an 8-bit output signal. The 8-bit output of each PE 88, 90, 92, 94, 96 is then sign-extended and shifted (multiplied) in a corresponding shifter 98, 100, 102, 104, 106 to generate a 16-bit shifted output signal. The shifted outputs are then summed together with a delayed version of the uncompensated 16-bit signal x(n) in accumulator 108. The delayed version of x(n) is received from delay unit 86. The accumulator 108 is where the actual subtraction of nonlinear effects from x(n) is taking place. The subtraction is achieved by the use of negating coefficients.

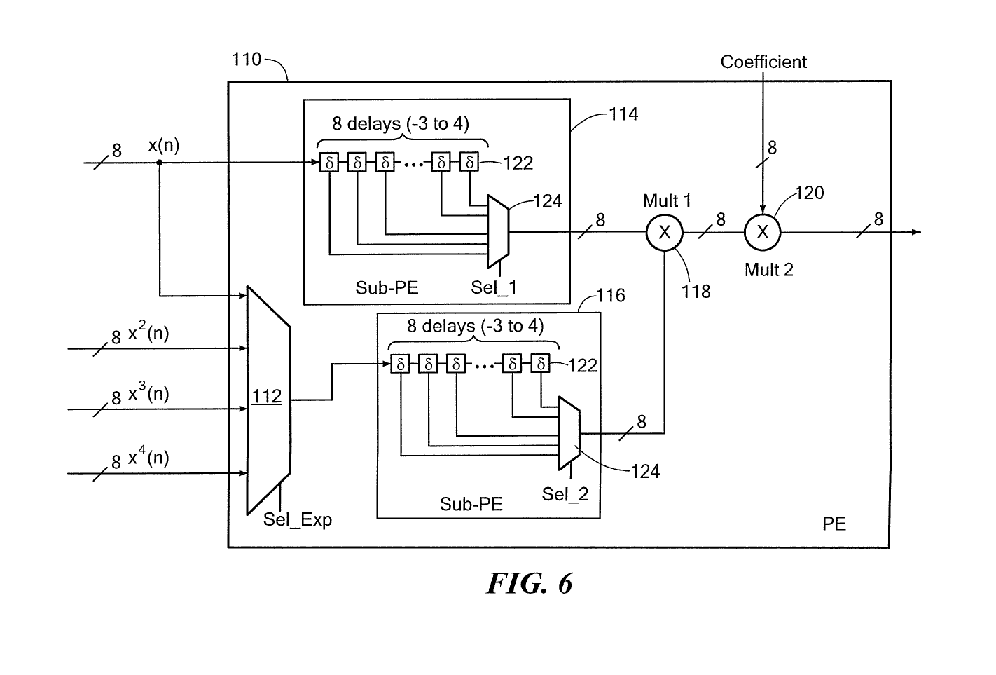

FIG. 6 is a block diagram of an example processing element 110 in accordance with an embodiment. Processing element 110 may be used within, for example, digital equalizer circuit 80 of FIG. 5 and/or other equalization circuits. As illustrated, processing element 110 includes: a multiplexer 112, first and second delay blocks (or sub-processing elements) 114, 116, and first and second multipliers 118, 120. Delay blocks 114, 116 are each operative for delaying an input signal by a desired amount. First delay block 114 delays the truncated (8-bit) version of input signal x(n) by a first delay amount. Second delay block 116 delays a truncated version of either the input signal x(n) or the second, third, or fourth powers of x(n) (as selected by multiplexer 112) by a second delay amount. The delayed output signals of first and second delay blocks 114, 116 are multiplied together in first multiplier 118 to form a first product. To conserve power, the first product may be truncated to a particular number of MSBs (e.g., 8-bits, etc.) in some embodiments. The first product may then be multiplied by a predetermined coefficient in second multiplier 120 to form a second product, which serves as the output signal of processing element 110.

In at least one implementation, each of the delay blocks 114, 116 may include a series of delay elements 122 and a multiplexer 124. The delay elements 122 may each have an output that is coupled to an input of multiplexer 124. A signal to be delayed is applied to an input of the series of delay elements 122 and allowed to propagate through the elements. Multiplexer 124 is then able to select an output signal of one of the delay elements 122 that has a desired delay amount for passage to an output. Other types of delay blocks may be used in other implementations.

The signal selected by multiplexer 112, the delay values used in first and second delay blocks 114, 116, and the coefficient used by second multiplier 120 may each be determined during a training operation to achieve a desired equalizer response for a corresponding equalizer (e.g., digital equalizer circuit 80 of FIG. 5). After training, control signals may be sent to the corresponding components of processing element 110 to configure the element. In general, each processing element in an equalizer will be independently configured to achieve a desired equalizer response.

It should be appreciated that digital equalizer circuit 80 of FIG. 5 and processing element 110 of FIG. 6 are merely examples of different circuits that may be used to perform digital compensation in various implementations. Many alternative compensation architectures may be used.

In method 10 of FIGS. 1 and 2, after an initial analog receiver has been designed, nonlinear distortion components within an output signal of the analog receiver are identified. A digital compensation architecture may then be designed to reduce the nonlinear components, and the power consumption of the digital compensation architecture is estimated. When an equalizer similar to the one of FIG. 5 is used as part of the digital compensation architecture, the power consumption may be estimated in a relatively straightforward manner. In such an implementation, the power consumption will primarily depend upon the order of the polynomial used, the number of delays used, and the number of processing elements used (which may each include delay blocks and multipliers). In one approach, an equation may be generated to estimate the power consumption based on these variables. As will be appreciated by persons of ordinary skill in the art, the specific technique for estimating the power consumption of the digital compensation circuitry will typically depend upon the digital compensation architecture used.

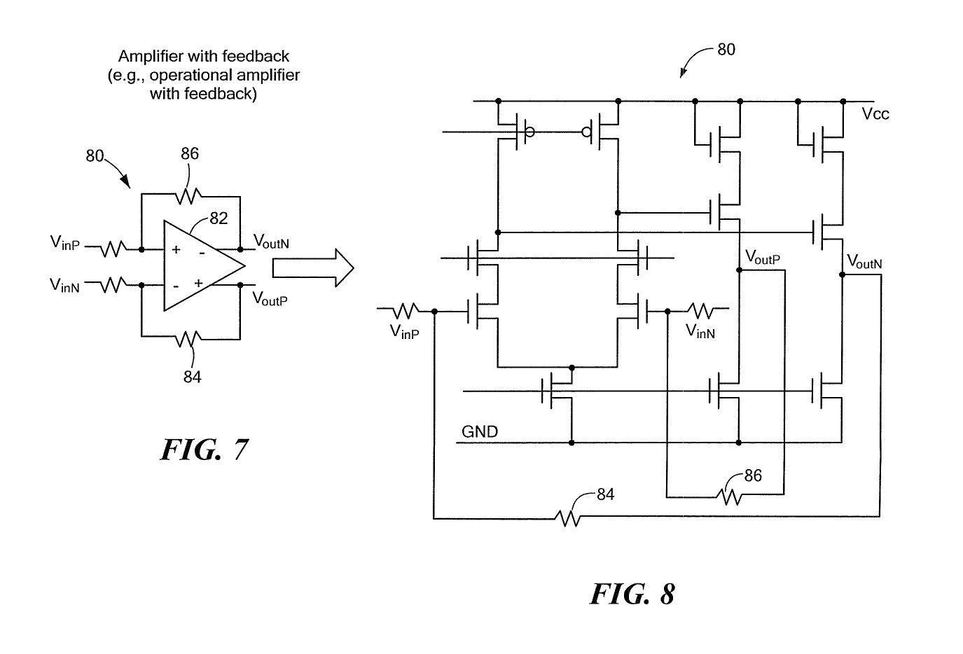

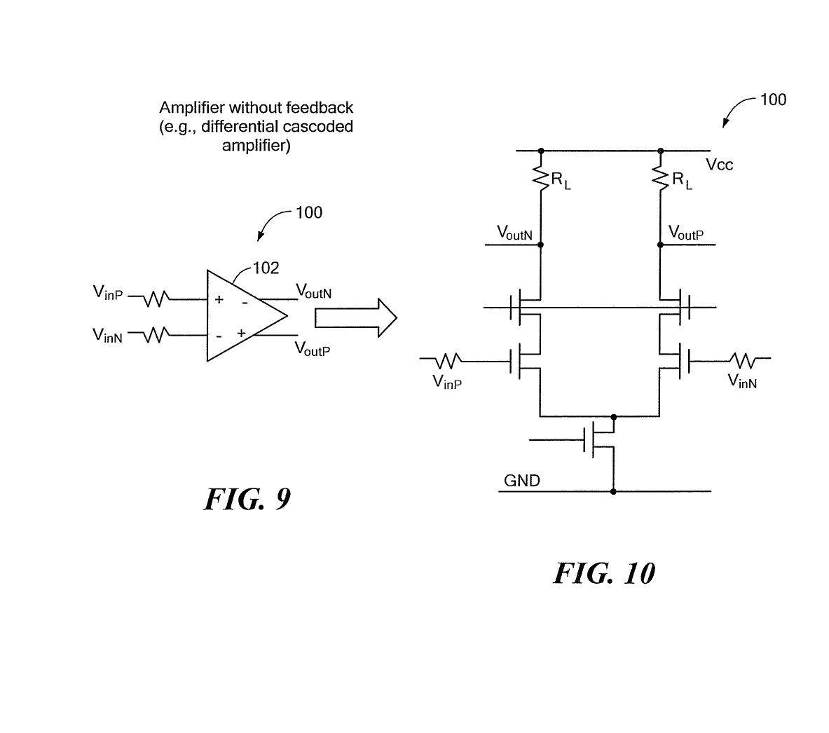

FIG. 7 is a schematic diagram of an amplifier circuit 80 that may be used within an analog receiver design in accordance with an implementation. During a receiver design process, amplifier circuit 80 may be considered for use as, for example, an output buffer amplifier in an analog receiver chain that will drive an analog to digital converter (e.g., buffer amplifier 60 of FIG. 6, etc.). As shown, amplifier circuit 80 includes an operational amplifier 82 having feedback provided by a pair of feedback resistors 84, 86. The feedback may be implemented to, among other things, improve the linearity of amplifier circuit 80. FIG. 8 is a more detailed schematic diagram of amplifier circuit 80 showing internal circuitry of operational amplifier 82. FIG. 9 is a schematic diagram of an amplifier circuit 100 that may be considered as an alternative to amplifier circuit 80 of FIG. 7 during the same receiver design process. As shown, amplifier circuit 100 includes a differential amplifier 102 that does not use feedback. FIG. 10 is a more detailed schematic diagram of amplifier circuit 100 showing the internal circuitry of differential amplifier 102 as a cascode amplifier.

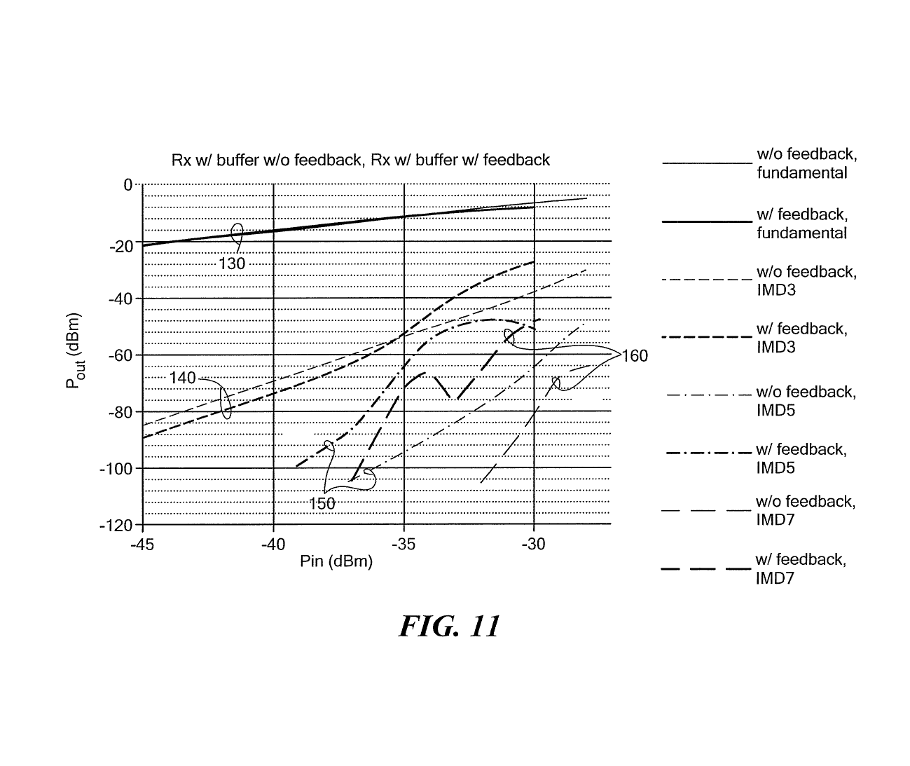

FIG. 11 is a plot illustrating output power versus input power for a first receiver having a buffer that uses feedback (e.g., amplifier circuit 80 of FIG. 7) and a second receiver having a buffer that doesn't use feedback (e.g., amplifier circuit 100 of FIG. 9). Other than the buffer amplifier used, the first and second receivers are substantially the same. The plot of FIG. 11 includes first curves 130 corresponding to the fundamental frequency of the two receivers, second curves 140 corresponding to the third-order inter-modulation product (IMD3), third curves 150 corresponding to the fifth-order inter-modulation product (IMD5), and fourth curves 160 corresponding to the seventh-order inter-modulation product (IMD7). For the most part, in each case, the inter-modulation product component for the receiver that uses feedback is lower than the receiver that does not use feedback. However, as illustrated, the inter-modulation products of the receiver that uses a buffer with feedback differ from their respective 3×, 5×, and 7× slopes of the fundamental by a much wider margin than the corresponding slopes for the other receiver. This makes the identification of nonlinear distortion terms more complicated and results in a more complex digital equalizer to achieve a desired level of linearity performance.

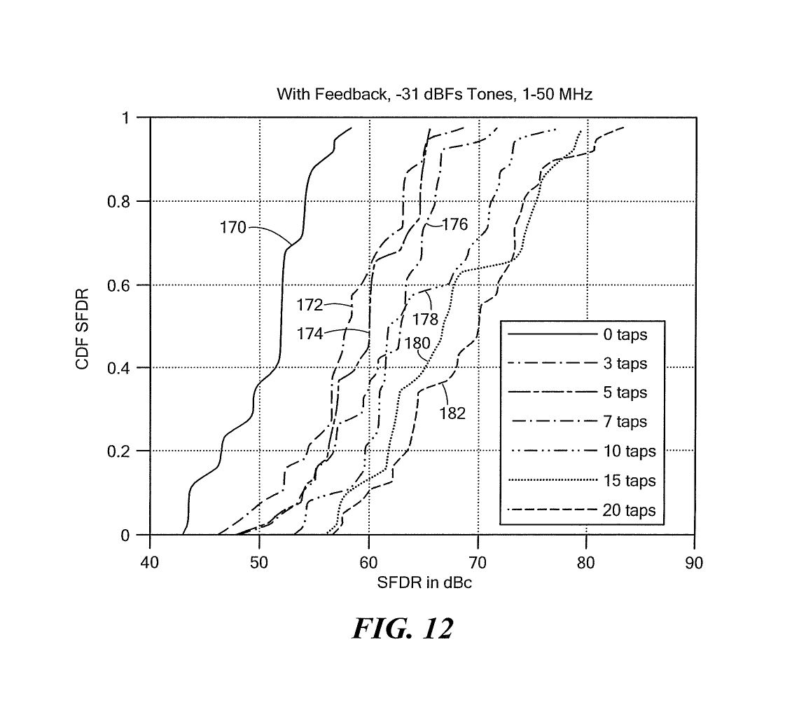

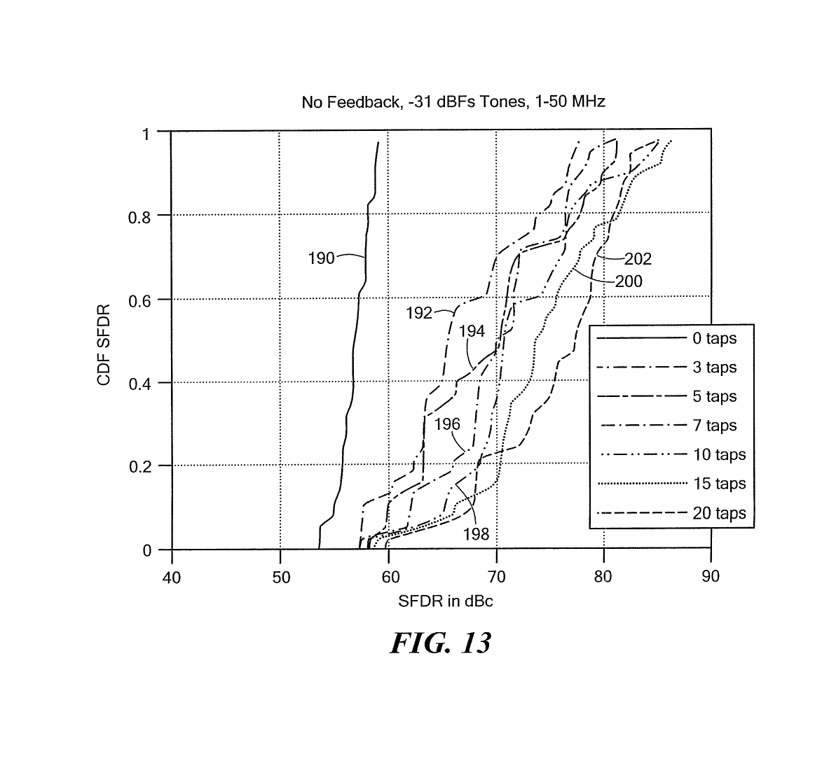

FIG. 12 is a plot showing measured spurious free dynamic range (SFDR) for a receiver that uses feedback within the buffer and FIG. 13 is a plot showing measured SFDR for a receiver that does not use feedback within the buffer, for various levels of digital compensation. FIG. 12 includes a curve 170 for no digital compensation, a curve 172 for a 3-tap digital equalizer, a curve 174 for a 5-tap digital equalizer, a curve 176 for a 7-tap digital equalizer, a curve 178 for a 10-tap digital equalizer, a curve 180 for a 15-tap digital equalizer, and a curve 182 for a 20-tap digital equalizer. Likewise, FIG. 13 includes a curve 190 for no digital compensation, a curve 192 for a 3-tap digital equalizer, a curve 194 for a 5-tap digital equalizer, a curve 196 for a 7-tap digital equalizer, a curve 198 for a 10-tap digital equalizer, a curve 200 for a 15-tap digital equalizer, and a curve 202 for a 20-tap digital equalizer. As shown in the figures, in this particular instance, the receiver that uses a buffer without feedback (FIG. 13) achieves better linearity performance, even when no digital compensation is used. This is not an expected result. That is, a receiver that uses a buffer with feedback normally achieves better linearity performance. But as the drive level exceeds the level that the feedback loop can correct for, the feedback is not as effective, showing worse linearity performance than the receiver that uses a buffer without feedback. In addition, a more predictable nonlinear behavior of the receiver that uses a buffer without feedback makes the digital compensation more effective and simpler. Typically, a designer would not be aware of the above described information before a receiver design task is undertaken, potentially resulting in a receiver that consumes much more power than needed. The receiver design methods described herein provide an enhanced technique for achieving lower power receiver designs in an efficient and systematic manner.

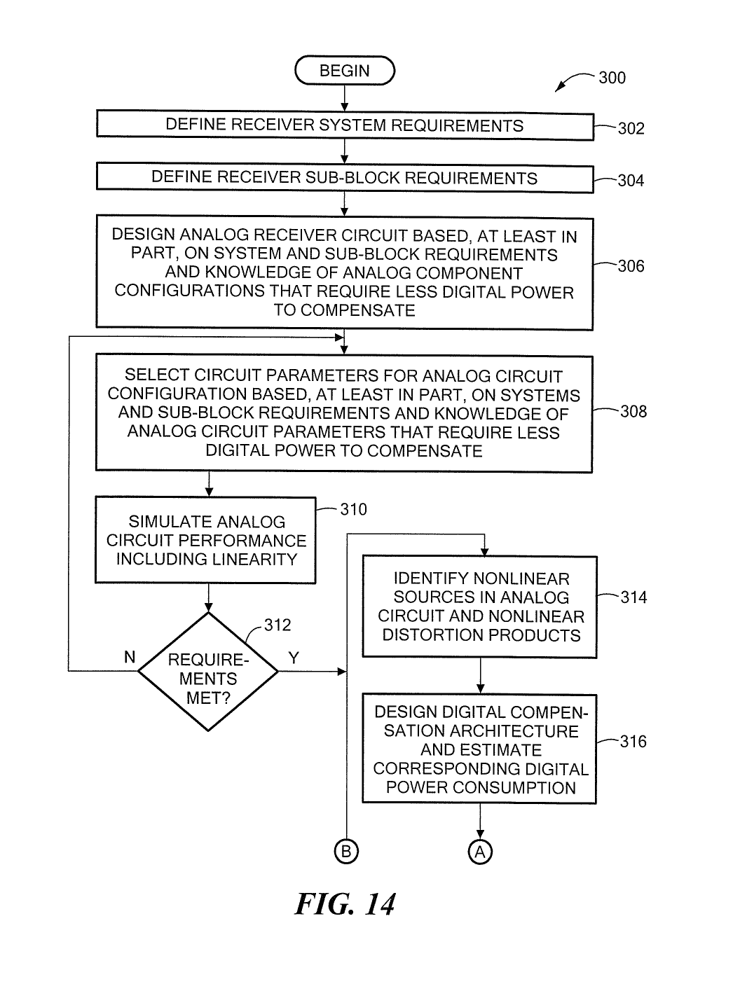

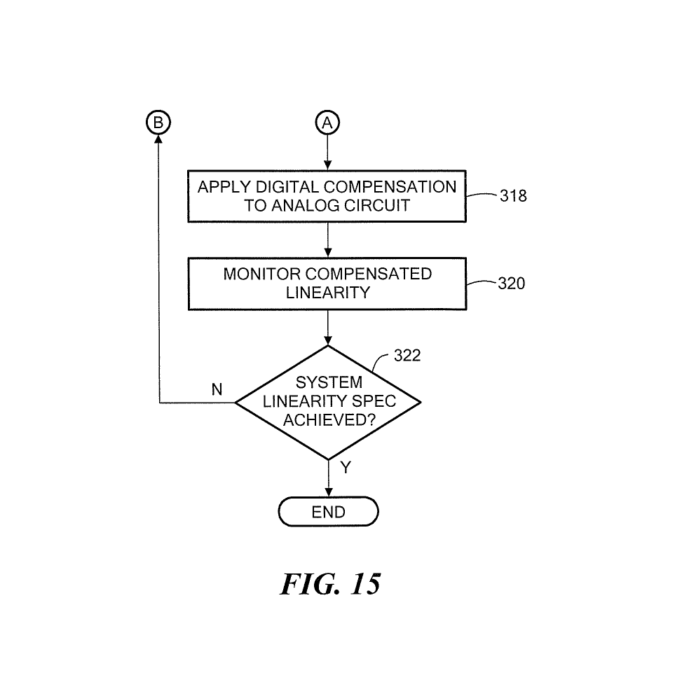

After using the design techniques described above for a while, a designer may begin to gain knowledge of different analog receiver architectures, and/or individual receiver component architectures or designs, that require less digital compensation to achieve a desired receiver linearity. In such cases, a simpler design process may be used to achieve a low power receiver. FIGS. 14 and 15 are portions of a flowchart illustrating such a method 300 in accordance with an embodiment. As before, system requirements and/or sub-block requirements may first be defined for the receiver system (blocks 302, 304). An analog receiver system architecture may then be selected based, at least in part, on the system and/or sub-block requirements and knowledge of analog component configurations that require less power to digitally compensate (block 306). Circuit parameters may also be selected for the analog receiver system based, at least in part, on the system and/or sub-block requirements and knowledge of analog circuit parameters that require less power to digitally compensate (block 308).

As before, after the analog architecture and the analog circuit parameters have been selected, the performance of the analog receiver circuit may be simulated to determine whether system and/or sub-block requirements have been achieved (block 310). If certain requirements have not been achieved, changes may be made to the circuit parameters until desired analog performance is achieved (block 312). Because digital nonlinearity compensation is to be used, however, the system linearity requirement does not need to be met at this point.

After an analog design is determined, sources of nonlinearity and nonlinear distortion components may be identified (block 314). A digital compensation architecture may then be designed and the power consumption of the digital compensation circuitry may be estimated (block 316). Referring now to FIG. 15, the digital compensation architecture may next be applied to the analog receiver system (block 318) and the linearity performance of the modified system may be simulated (block 320). If the modified system does not achieve the specified system linearity requirement (block 322-N), then the method 300 may repeat the digital design process to make modifications to the digital compensation architecture. This process may then be repeated until the system linearity requirement has been achieved or some other condition has been met (e.g., a maximum number of design iterations has occurred, etc.). Because analog components have been used that are known to require a reduced level of digital nonlinearity compensation, additional design iterations to try other analog design configurations may not be required. However, in some implementations, one or more alternative analog configurations may be tried even if knowledge of optimal analog circuitry is used during the initial analog design phase.

The methods described herein may be used to design receivers for use in any of a wide range of different applications including, for example, wireless and/or wireline communications, optical communications, satellite communications, cable television applications, computer networking applications, cellular communications systems, and/or any other application where linear operation with lower power consumption may be desired.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method for designing a receiver system, comprising:
generating an initial analog receiver design;
characterizing nonlinearities in the initial analog receiver design;
designing digital nonlinearity compensation circuitry for the initial analog receiver design based on the nonlinearities and applying the digital nonlinearity compensation circuitry to the initial analog receiver design; and
modifying the analog receiver design and the digital nonlinearity compensation circuitry to identify a combination of the two that achieves a receiver linearity requirement with relatively low power consumption.

2. The method of claim 1, wherein:
modifying includes modifying the analog receiver design and the digital nonlinearity compensation circuitry in an iterative manner.

3. The method of claim 1, wherein:
modifying includes modifying the analog receiver design and the digital nonlinearity compensation circuitry to identify a combination of the two that achieves the receiver linearity requirement with relatively low power consumption in the digital nonlinearity compensation circuitry.

4. The method of claim 3, further comprising:
estimating power consumption of the digital nonlinearity compensation circuitry each time the digital nonlinearity compensation circuitry is modified.

5. The method of claim 4, wherein:
the digital nonlinearity compensation circuitry includes an analog to digital converter (ADC) and a digital equalizer having a plurality of taps.

6. The method of claim 5, wherein:
modifying the analog receiver design and the digital nonlinearity compensation circuitry to identify a combination of the two that achieves the system linearity requirement with relatively low power consumption in the digital nonlinearity compensation circuitry includes identifying an analog receiver design that requires a lowest number of computations in the digital equalizer to achieve the receiver linearity requirement.

7. A method for designing a receiver comprising an analog receiver chain followed by a digital equalization circuit, the method comprising:
selecting components for the analog receiver chain that allow the analog receiver chain to achieve receiver design requirements other than a receiver linearity requirement; and
designing the digital equalization circuit to reduce non-linear distortion components in an output signal of the analog receiver chain in a manner that achieves the receiver linearity requirement;
wherein selecting components for the analog receiver chain includes selecting components having nonlinear characteristics that require a relatively small number of computations within the digital equalization circuit to achieve the receiver linearity requirement.

8. The method of claim 7, wherein:
selecting components for the analog receiver chain includes selecting components having nonlinear characteristics that require relatively low power consumption in the digital equalization circuit to achieve the receiver linearity requirement.

9. The method of claim 7, wherein:
selecting components for the analog receiver chain includes selecting components having nonlinear characteristics that require a minimum level of power consumption in the digital equalization circuit to achieve the receiver linearity requirement.

10. A method for designing a receiver comprising an analog receiver chain followed by a digital compensation circuit, the method comprising:
identifying multiple candidate analog receiver chain designs that are capable of achieving receiver design requirements other than a receiver linearity requirement;
designing digital compensation circuits for each of the candidate analog receiver chain designs to achieve the receiver linearity requirement; and
selecting an analog receiver chain/digital compensation circuit combination having a lowest power consumption.

11. The method of claim 10, wherein:
selecting an analog receiver chain/digital compensation circuit combination having a lowest power consumption includes selecting a combination having a lowest power consumption for the full receiver.

12. The method of claim 10, wherein:
selecting an analog receiver chain/digital compensation circuit combination having a lowest power consumption includes selecting a combination having a lowest power consumption in the digital compensation circuit.

13. The method of claim 12, wherein:
designing digital compensation circuits includes designing a digital equalizer for each of the candidate analog receiver chain designs; and
selecting an analog receiver chain/digital compensation circuit combination having a lowest power consumption includes selecting a combination that includes a lowest number of active taps within a corresponding digital equalizer.

14. The method of claim 12, further comprising:
estimating a digital power consumption of each digital compensation circuit designed, wherein selecting an analog receiver chain/digital compensation circuit combination having a lowest power consumption includes selecting a combination having a lowest estimated digital power consumption.

15. A method for designing a receiver system, comprising:
generating an analog receiver design based on specified system requirements;
defining operational constraints for components of the analog receiver design to limit nonlinearity in the analog receiver design while achieving component performance requirements;
characterizing non-linearities in the analog receiver design operating under the operational constraints; and
designing supplemental digital compensation circuitry for the analog receiver design operating under the operational constraints to reduce non-linear distortion components in an output signal thereof;
wherein generating an analog receiver design includes selecting components for the analog receiver design that require a low level of supplemental digital compensation to achieve a receiver linearity requirement.

16. The method of claim 15, wherein:
defining operational constraints for components of the analog receiver design includes limiting operation of amplifiers in the analog receiver design to a 1 dB compression point and below.

17. The method of claim 15, wherein:
characterizing non-linearities in the analog receiver design includes performing a calibration procedure that includes delivering a series of multi-tone signals to an input of the analog receiver design and analyzing resulting output signals.

18. The method of claim 15, wherein:
generating an analog receiver design includes selecting components for the analog receiver design that require minimal power consumption in the supplemental digital compensation circuitry to achieve the receiver linearity requirement.

19. A method for designing a receiver system, comprising:
designing an analog receiver circuit based, at least in part, on specified receiver requirements;
selecting circuit parameters for the analog receiver circuit based, at least in part, on the specified receiver requirements;
identifying nonlinear distortion components in an output signal of the analog receiver circuit and sources of the nonlinear distortion components within the analog receiver circuit;
designing a digital compensation circuit for the analog receiver circuit to reduce nonlinear distortion components within the output signal of the analog receiver circuit and estimating power consumption of the digital compensation circuit;
measuring linearity of the digitally compensated analog receiver circuit and, if a receiver linearity requirement has not been achieved, repeating identifying nonlinear distortion components, designing a digital compensation circuit, and measuring linearity until the receiver linearity requirement is achieved; and
when the system linearity requirement has been achieved, determining whether a power condition has been satisfied and, if not, repeating designing an analog receiver circuit, selecting circuit parameters, identifying nonlinear distortion components, designing a digital compensation circuit, measuring linearity, and determining until the power condition has been satisfied.

20. The method of claim 19, wherein:
the power condition includes achieving a predetermined power consumption in the digital compensation circuit.

21. The method of claim 19, wherein:
the power condition includes achieving a minimal power consumption in the digital compensation circuit.

22. The method of claim 19, wherein:
the power condition includes performing a predetermined number of iterations of designing an analog receiver circuit, selecting circuit parameters, identifying nonlinear distortion components, designing a digital compensation circuit, measuring linearity, and determining.

23. The method of claim 19, wherein:
identifying nonlinear distortion components includes performing a calibration procedure that includes delivering a series of multi-tone signals to an input of the analog receiver circuit and analyzing resulting output signals.

24. A receiver comprising:
an analog receiver chain having a plurality of analog circuit components, each of the analog circuit components having known nonlinear response characteristics; and
a digital equalizer coupled to an output of the analog receiver chain, the digital equalizer to reduce one or more nonlinear distortion components in an output signal of the analog receiver chain to achieve a receiver linearity requirement, wherein the circuit components of the analog receiver chain are selected to achieve low power consumption in the digital equalizer.

25. The receiver architecture of claim 24, wherein:
the analog receiver chain includes a number of amplifiers, all of which are driven at or below their 1 dB compression points under normal operating conditions.

26. The receiver architecture of claim 24, wherein:
the circuit components of the analog receiver chain are selected to achieve minimum power consumption in the digital equalizer.
